(19) United States
(12) Patent Application Publication
(10) Pub. No.: US 2006/0260590 A1
(43) Pub. Date: Nov. 23, 2006

(54) Control apparatus utilizing engine negative pressure for improving combustion efficiency thereof

(76) Inventor: Chun Chou Lin, Taiping City (TW)

Correspondence Address: TROXELL LAW OFFICE PLLC, SUITE 1404, 5205 LEESBURG PIKE, FALLS CHURCH, VA, 22041, US

(21) Appl. No.: 11/130,091

(22) Filed: May 17, 2005

(51) Int. Cl. F02B 23/00; F02M 23/00

(52) U.S. Cl. 123/585; 123/587

(57) ABSTRACT

A control apparatus utilizing engine negative pressure for improving combustion efficiency thereof includes an air intake control body that can provide sufficient and accurate amount of air supply required to maintain a proper air-fuel mixture so as to facilitate adequate combustion of gasoline or diesel oil and achieve oil-saving effect thereby. The air-intake control body of the present invention is made up of an air intake vent, a main outlet vent, a linkage passageway extending at the bottom of both air intake vent and the main outlet vent to reciprocally connect and communicate both thereby, and a bifurcated air vent properly branching from the main outlet vent that also has a spring, a metallic ball, an adjusting valve, and an air outlet connector mounted therein to comprise a one-way air passageway for the irreversible travel of intake air there-through. The air outlet connector thereof is linked with air intake manifold of an engine so that the air intake of the running engine will generate an air-flow siphon effect and activate the control body to draw in outside air and provide sufficient air supply for use of the engine, economically improving the combustion efficiency thereby.

### BACKGROUND OF THE INVENTION

The present invention is related to a control apparatus utilizing engine negative pressure for improving combustion efficiency thereof, including an air intake control body activated by a negative pressure generated in the air intake of a running engine to suck in outside air and provide adequate and accurate amount of air required to maintain proper air-fuel mixture so as to facilitate sufficient combustion of gasoline or diesel oil thereby, efficiently achieving automatic control of adequate air supply and economically improving the combustion efficiency and oil-saving effect thereof.

One of the keys to control the consumption of oil is to provide adequate amount of air in the air-fuel mixture for sufficient combustion of gasoline or diesel oil so as to provide power necessary for the engine. An insufficient combustion thereof can result in a waste of oil and interfere the proper function of the engine. Thus, either by the design of the mechanism of a car itself or a built-in oil-saving device is required for the purpose thereof. In respect of the mechanism of a car itself, the problem thereof is coped with in the mechanism of a car itself such as a carburetor, a vacuum booster, and air intake manifold (intake valve). However, these mechanic parts can easily deteriorate (get worn or blocked) over long time of use and cause the problem of insufficient air supply thereof. However, the conventional built-in oil-saving devices on the market are complex in structure and huge in volume. Besides, most of conventional oil-saving devices, individually operated, must be tuned in a specific setup instead of adjusting itself automatically according to the inner state of the engine. Thus, the conventional oil-saving device can increase the burden of the engine (due to over-combustion thereof) and tend to shorten its lifetime thereby.

### SUMMARY OF THE PRESENT INVENTION

It is, therefore, the primary purpose of the present invention to provide a control apparatus utilizing engine negative pressure for improving combustion efficiency thereof, including an air-intake control body made up of an air intake vent, a linkage passageway, a main outlet vent, and a bifurcated air vent branching from the main outlet vent thereof wherein the main outlet vent also has an adjusting valve, a spring, a metallic ball, and a filter accommodated therein to comprise a one-way air passageway for the irreversible travel of intake air there-through, providing an efficient air-intake control apparatus that is simple in structure and small in volume.

It is, therefore, the second purpose of the present invention to provide a control apparatus utilizing engine negative pressure for improving combustion efficiency thereof wherein the air-intake control body of the present invention is directly connected to a tube linked to air intake manifold of an engine so that when the engine is started to draw in outside air, the control body thereof will be activated by the air-flow “siphon effect” generated by the air intake of the running engine thereof so as to suck in outside air for use of the engine and constitute a “self-sufficient” air supply effect to automatically provide adequate air according to the scale of the combustion of the engine, economically improving the combustion efficiency and achieving the best using state thereof.

### BRIEF DESCRIPTION OF THE DRAWINGS

FIG. 1 is an exploded perspective and partially cross sectional view of the present invention.

FIG. 2 is a front side and cross sectional view of the present invention in assembly.

FIG. 3 is a lateral side and cross sectional view of the present invention in assembly.

FIG. 4 is a diagram showing the layout of a car system with the present invention built therein.

FIG. 5 is a diagram showing the intake of outside air to the present invention.

FIG. 6 is a diagram showing the present invention adjusted to regulate the volume of intake air in practical use.

### DETAILED DESCRIPTION OF THE PREFERRED EMBODIMENTS

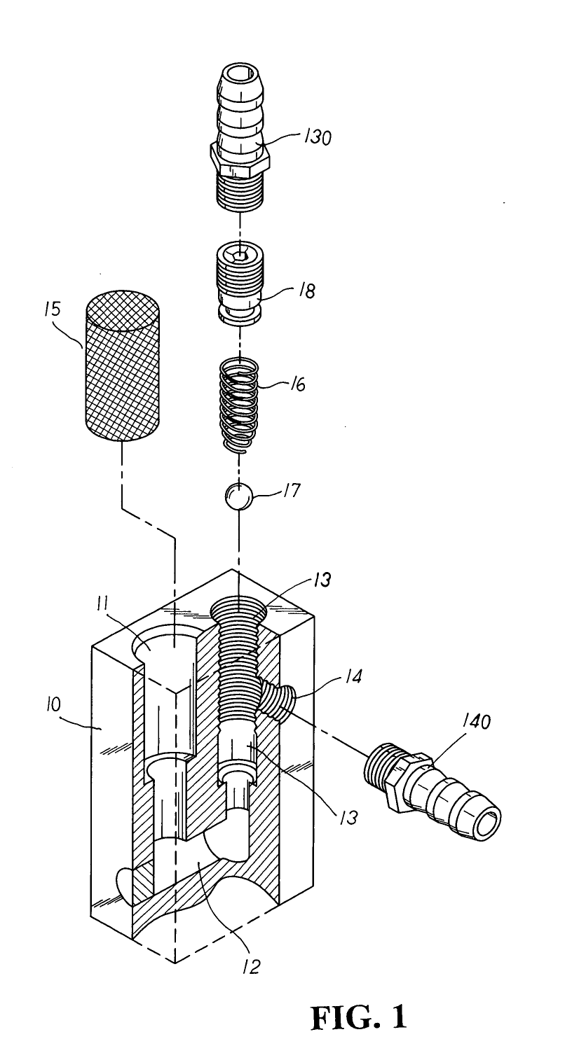

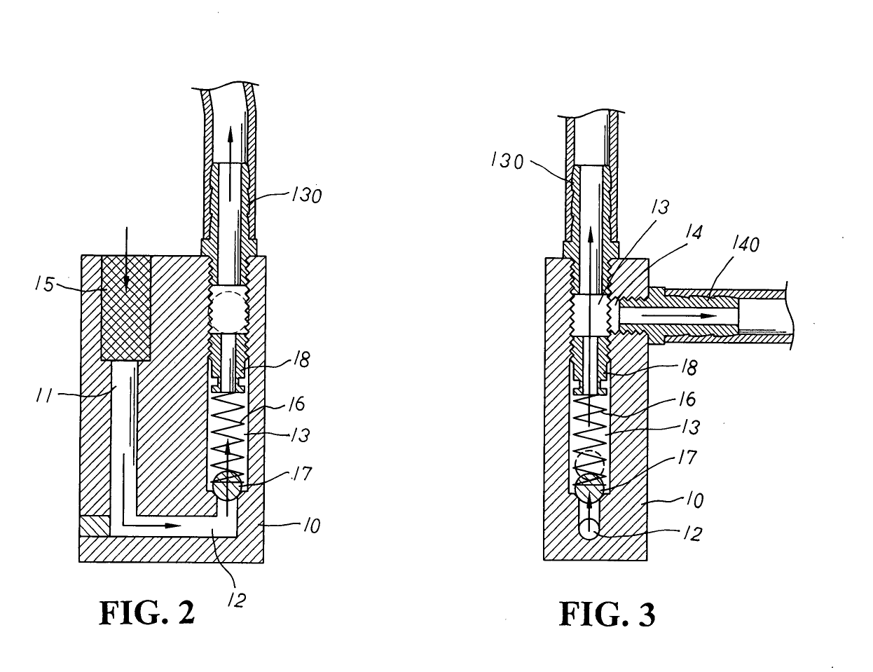

Please refer to FIG. 1 showing an exploded perspective and partially cross sectional view of the present invention (accompanied by FIGS. 2, 3). The present invention is related to a control apparatus utilizing engine negative pressure for improving combustion efficiency thereof, including a control body 10 made up of an air intake vent 11, a main outlet vent 13, a linkage passageway 12 extending at the bottom of both air intake vent 11 and the main outlet vent 13 to reciprocally connect and communicate both thereby. The main outlet vent 13 has a bifurcated air vent 14 properly branching there-from and in communication therewith, and the air intake vent 11 has a filter 14 accommodated therein to screen dirt or particles from the intake air thereby. The main outlet vent 13 also has a spring 16, a metallic ball 17, an adjusting valve 18, and an air outlet connector 130 mounted therein to comprise a one-way air passageway for the irreversible travel of intake air there-through. The air outlet connector 130 thereof is coupled with air intake manifold of an engine, and the bifurcated air vent 14 has an air outlet coupler 140 attached thereto to connect with the piping of a vacuum booster of a car braking system.

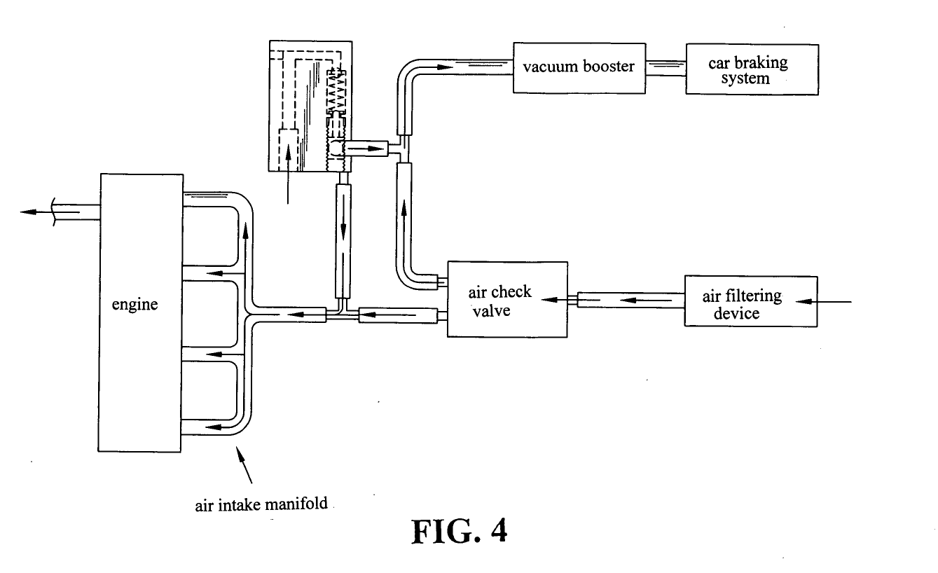

Please refer to FIG. 4 showing the layout of a car system with the present invention built therein. The air outlet connector 130 of the main outlet vent 13 is matched to the layout of a piping system and joined to an air intake tube of an engine (such as that connected to an air check valve and the air intake manifold), and the air outlet coupler 140 thereof, also matched to the layer out of the piping system, is connected to a tube led to a car braking and pressure-boosting system (e.g. that situated between a vacuum booster and the air check valve thereof whereas, in the car braking system, an air pressure is generated to actuate a fuel pressure thereby, and the air supply thereof comes from the piping through the air check valve thereof). When the engine is started, air outside will be sucked in and transported through an air filtering device, the air check valve, and the air intake manifold to provide the air supply for the engine. Meanwhile, the control body 10 will be activated by the air intake of the running engine to draw in outside air through the air intake vent 11 thereof. Due to the spring 16, and the metallic ball 17 sealed at the bottom of the main outlet vent 13, the intake air can only travel in one-way direction (towards the main outlet vent 13) inside the control body 10 till transported to the air intake manifold and then to the engine to generate an air-flow “siphon effect” that will suck upwards the metallic ball 17 and open the main outlet vent 13, allowing outside air to enter the air intake vent 11 and travel through the linkage passageway 12 thereof before transported outwards through the main outlet vent 13 thereof. Meanwhile, the metallic ball 17 thereof is precisely lifted and supported by the intake air to keep the main outlet vent 13 in an open state thereby so that the intake air can be continuously supplied through the main outlet vent 13 to the engine thereof in an incessant flow thereby.

Therefore, the present invention employs the spring 16 and the metallic ball 17 to provide a one-way air flow control apparatus and utilizes the air intake of the engine to generate an air-flow “siphon effect” and activate the air-intake operation of the control body 10 thereby. No matter it's the gasoline or the diesel oil employed, air must be supplied to start the combustion of the engine thereof. In addition to the air supply drawn in through the air filtering device and the air check valve thereof, the present invention can accurately facilitate the intake of outside air to provide sufficient air supply to the engine. According to the air supply required for the combustion of the engine on different scales, the control body 10 of the present invention can generate different amounts of air supply to improve the combustion thereof. In case of a huge combustion when a large volume of air is required, the present invention can intake a larger volume of outside air to maintain a larger amount of fuel-air mixture for the combustion thereof. And in case of a small combustion (e.g. when the gas pedal is released) when air is adequately supplied by the original air-intake piping system thereof, the spring 16 will bounce the metallic ball 17 back to seal off the bottom of the main outlet vent 13 so as to shut off the air supply of the control body 10 thereof.

In the abovementioned structure thereof, when the engine is started to take in outside air through the air check valve and the air intake manifold thereof, the air intake is generated by a negative pressure with a “sucking force” to draw in outside air. Thus, when the main outlet vent 13 of the present invention is connected to the air intake manifold and activated in an air-intake state, the air drawn into the control body 10 thereof is respectively transported to the bifurcated air vent 14 and the main outlet vent 13 and emitted outwards through the air outlet connector 130 thereof so as to provide subsidiary intake air supply to the engine thereby. Via synchronic air-flow “siphon effect” thereof, the present invention can provide sufficient air supply to the engine so as to facilitate adequate fuel-air mixture for the combustion thereof and, thus, improve the combustion efficiency thereof.

Moreover, in addition to the air taken from the air check valve thereof, the bifurcated air vent 14 of the present invention can also supply air for use of the car braking and pressure-boosting system thereof. When the engine requires air supply in time of braking, the bifurcated air vent 14 can help support the air supply required for the braking system and reduce the air subdivided from the air check valve thereof. Therefore, the intake air coming through the air check valve thereof can adequately support the engine, reducing the interference of the braking system in the air supply thereof and, thus, avoiding the stop of the engine (as the reason that causes the engine of an old car to a stop when the braking system is triggered to slow down in speed).

As shown in the aforementioned structure, the air-intake control apparatus of the present invention features a simple structure and small volume, which makes it cheap and easy to install into a car. The control apparatus thereof is powered by the utilization of a negative pressure generated in the air intake of the running engine. And depending on the scale of the combustion intensity thereof, the control apparatus thereof can provide different amount of air supply for use of the engine. In other words, via the different volume of the air intake of the running engine, the control apparatus of the present invention can change the output of the air amount and maintain sufficient air supply for use of the engine to achieve automatic control of proper air-fuel mixture function thereby.

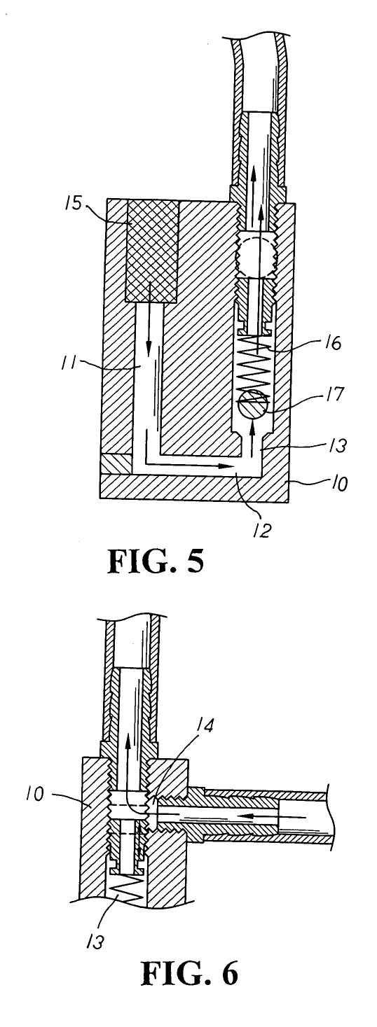

Please refer to FIGS. 5 to 6 inclusive. The caliber of the bifurcated air vent 14 can be regulated in size to control the intake and output of the air amount. Via the depth of the adjusting valve 18 screwed into the main outlet vent 13 to properly block the bifurcated air vent 14 branching from the main outlet vent 13 thereof, the caliber size of the bifurcated air vent 14 can be rectified so as to adjust the sucking-in force of the air intake and thus regulate the intake and output of air supply for use of the engine thereof.

What is claimed is:

1. A control apparatus utilizing engine negative pressure for improving combustion efficiency thereof, including a control body made up of an air intake vent, a main outlet vent, a linkage passageway extending at the bottom of both air intake vent and the main outlet vent to reciprocally connect and communicate both thereby wherein the main outlet vent has a bifurcated air vent properly branching there-from in mutual communication therewith, and the air intake vent has a filter accommodated therein to screen dirt or particles from the intake air thereby; the main outlet vent also has a spring, a metallic ball, an adjusting valve, and an air outlet connector mounted therein to comprise a one-way air passageway for the irreversible travel of intake air there-through; the air outlet connector thereof is coupled with air intake manifold of an engine, and the bifurcated air vent has an air outlet coupler attached thereto to connect with the piping of a car braking and pressure-boosting system; via the aforementioned structure, when the engine is started to draw in outside air, the control body thereof will be activated by a negative pressure that, generated in the air intake of the running engine, will suck up the metallic ball and open the main outlet vent thereby, allowing outside air to enter the air intake vent and travel through the linkage passageway before transported outwards through the main outlet vent for use of the engine so as to provide sufficient air supply required to maintain adequate fuel-air mixture for the combustion of the engine thereof and, thus, improve the combustion efficiency thereof.
